(19) United States
(12) Patent Application Publication
(10) Pub. No.: US 2014/0039943 A1
(43) Pub. Date: Feb. 6, 2014

(54) DYNAMIC AND HIERARCHICAL GENERIC DATA MAPPING FOR TRAVELER PROFILE PUBLICATION

(71) Applicants: Dorina Ghindici, Juan Les Pins (FR); Bruno Martinez, Mouans Sartoux (FR); Philippe Losco, Mouans Sartoux (FR); Lionel Martig, Biot (FR); Philippe Beaudequin, Le Rouret (FR)

(72) Inventors: Dorina Ghindici, Juan Les Pins (FR); Bruno Martinez, Mouans Sartoux (FR); Philippe Losco, Mouans Sartoux (FR); Lionel Martig, Biot (FR); Philippe Beaudequin, Le Rouret (FR)

(73) Assignee: AMADEUS S.A.S., Sophia Antipolis Cedex (FR)

(21) Appl. No.: 13/565,102

(22) Filed: Aug. 2, 2012

(51) Int. Cl. G06Q 10/02

(52) U.S. Cl. 705/5

(57) ABSTRACT

A method, apparatus, and program product suitable for use in the travel industry utilize a dynamic and hierarchical generic data mapping model to facilitate the publication of traveler profile data from a source system, such as a profile management system, to a plurality of downstream target systems. A generic data mapping model may be utilized to dynamically build a target-specific publication data mapping, e.g., in association with the publication of a traveler profile, such that the traveler profile may be transformed into a target format using the dynamically built publication data mapping.

### FIELD OF THE INVENTION

The invention is generally related to computers and computer software, and in particular, to managing profile data for travelers.

### BACKGROUND OF THE INVENTION

Computer technology is increasingly used in the travel industry to manage and support travel reservations and data associated therewith. Initially, the travel industry focused on the delivery of very specialized travel reservations services for offline and online channels (e.g., computer reservations systems (CRS's), global distribution systems (GDS's), point-of-sales (POS) applications, mid-and-back office applications, self-booking tools (SBT's), etc.). Some peripheral services, such as profile management, which is used to manage of data associated with individual travelers, were also developed but were mainly designed to support these very specialized reservation services, and as a result, profile management has been found to be as specialized as the travel reservation services that rely on the profile data, with specific databases, data structures and data flows typically used for each channel and system. Furthermore, the technology infrastructure, which has supported these profile management services, has been based on multiple proprietary segmented solutions, so that the sharing of profile data across systems has traditionally been problematic.

With the emergence of the internet and mobile technologies, travelers increasingly are relying on a global travel shopping approach involving multiple channels during their travel shopping experiences. These new consumption modes, among many other economic and competitive factors, have strengthened the need for travel retailers to deliver global consistent services across all of their channels. By side effect, a need has arisen for a central repository for profile data that is accessible by multiple downstream systems, including but not limited to GDS's and SBT's. A repository for storing profile data for use by multiple downstream systems will hereinafter been referred to as a profile management system.

Given the different technology infrastructures, databases, data structures and data flows for different downstream systems, however, the provision of profile data stored in a profile management system in a manner that can be used by different downstream systems is a non-trivial problem. In addition, for some downstream systems, further complications may exist due to the need to format profile data in a particular manner that is compatible with a particular market, geographical region and/or corporation or organization.

The provision of profile data from a profile management system to a downstream system is typically referred to as publication, and typically involves some transformation of profile data from a format used by the profile management system, also referred to herein as a source system, into a different format used by the specific downstream system, also referred to herein as a target system. In order to perform the transformation, a publication data mapping is typically required to be generated and used so that a published profile will be presented to the target system in a format that is grammatically and semantically compatible with the target system. The publication data mapping is typically used by a transformation engine to apply the publication data mapping against profile data in the source format. This transformation results in the generation of profile data in the target format and suitable for publishing to the desired target system.

Traditionally, the definition of a publication data mapping and the integration of the publication data mapping into the profile management system is an offline process requiring several steps and many manual operations done by human operators. For example, an external customer may be required to fill out a form logically describing the publication data mapping and submit it to the entity the manages the profile management system. Functional experts in that entity may then validate the submitted forms and sent implementation requests to technical experts at the entity, who then implement the publication data mapping using a data transformation language such as Extensible Stylesheet Language (XSL). Thereafter, the publication data mapping may be stored and activated in the profile management system, and the functional experts may perform live profile publication tests to validate the new publication data mapping.

This process, however, has been found to be time consuming and fraught with delays, typically due to the complexity of the manual operations, the possibility of errors and the need to perform additional validation to correct such errors. In addition, from the standpoint of the profile management entity, the validation of submitted forms requires a high level of expertise and functional knowledge, requiring qualified agents trained on business context and product specification, as well as agents trained with sufficient technical expertise and knowledge of downstream system specificities.

These limitations are heightened when attempting to integrate new corporations, organizations, geographical regions and/or markets into a profile management system, requiring profiles to be published to a high number of downstream systems having their own unique data model and requiring their own publication data mappings.

Another drawback encountered in traditional approaches arises due to data mapping redundancy and maintenance cost. For a given travel retailer and in many downstream systems, some profile elements always have the same significance, while other profile elements may only depend on a particular corporation or organization or only depend on the market. As a result, there is often duplicated information in a profile management system, which leads to expensive maintenance, and often requiring many publication data mappings to be changed in response to updates to common target elements.

Therefore, a substantial need continues to exist in the art for an improved manner of managing and publishing traveler profile data in a profile management system.

### SUMMARY OF THE INVENTION

The invention addresses these and other problems associated with the prior art by providing a method, apparatus, and program product that utilize a dynamic and hierarchical generic data mapping model to facilitate the publication of traveler profile data from a source system, such as a profile management system, to a plurality of downstream target systems. A generic data mapping model consistent with the invention, for example, may be utilized to dynamically build a target-specific publication data mapping, e.g., in association with the publication of a traveler profile, such that the traveler profile may be transformed into a target format using the dynamically built publication data mapping.

In addition, a generic data mapping model consistent with the invention may be hierarchical in nature, such that a child/descendent generic data mapping in a hierarchical collection of generic data mappings may inherit one or more mapping elements defined in a parent/ancestor generic data mapping. As such, during generation of a publication data mapping from the descendent generic data mapping, one or more inherited mapping elements defined in the ancestor generic data mapping may be combined with one or more mapping elements defined within the descendent generic data mapping to configure the publication data mapping to convert source profile data to target profile data according to the both the defined and inherited mapping elements.

Therefore, consistent with one aspect of the invention, a publication data mapping is generated for use in publishing traveler profile data from a source system to a target system from among a plurality of target systems, where the source system is configured to store profile data for a plurality of travelers. A first generic data mapping associated with the target system and from a hierarchical collection of generic data mappings is accessed, where the hierarchical collection of generic data mappings defines a plurality of mapping elements, with each mapping element in the plurality of mapping elements defining a relationship between at least one source data element from the source system and a target data element from the target system. The first generic data mapping defines a first mapping element that maps at least one source data element to a first target data element, and the first generic data mapping is a descendent of a second data mapping in the hierarchical collection of generic data mappings, and which defines a second mapping element that maps at least one source data element to a second target data element. The first generic data mapping inherits the second mapping element from the second generic data mapping. The publication data mapping is dynamically generated based at least upon the first and second generic data mappings, and is configured to convert source profile data from the source system and for a traveler into target profile data associated with the first and second target data elements for the target system based upon the first and second mapping elements defined in the first and second generic data mappings.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram an exemplary data processing system suitable for implementing a dynamic and hierarchical generic data mapping model consistent with one embodiment of the present invention.

FIG. 2 is a block diagram of an exemplary hardware and software implementation of the system of FIG. 1.

FIG. 3 is a block diagram of an example generic data mapping capable of being utilized in the system of FIGS. 1-2.

FIGS. 4-5 are block diagrams of example hierarchical collections of generic data mappings capable of being utilized in the system of FIGS. 1-2

FIG. 6 is a block diagram of example parent and child generic data mappings capable of being utilized in the system of FIGS. 1-2 and illustrating the concept of inheritance in a generic data mapping model.

FIG. 7 is a block diagram of an example hierarchical collection of generic data mappings capable of being utilized in the system of FIGS. 1-2 and further illustrating the concept of inheritance in a generic data mapping model.

FIG. 8 is a block diagram illustrating updates to generic data mappings in the hierarchical collection of generic data mappings of FIG. 7.

FIG. 9 is a block diagram illustrating generation of merged generic data mappings from the hierarchical collection of generic data mappings of FIG. 7.

FIG. 10 is a block diagram illustrating dynamic generation of a publication data mapping in connection with publication of a traveler profile in the system of FIGS. 1-2.

FIG. 11 is a flowchart illustrating an exemplary routine for retrieving a publication data mapping in the system of FIGS. 1-2.

FIG. 12 is a block diagram illustrating dynamic generation of an XSLT-format publication data mapping in connection with publication of a traveler profile in the system of FIGS. 1-2.

FIG. 13 is a block diagram of an object model for a generic data mapping capable of being implemented in the system of FIGS. 1-2.

FIG. 14 is a block diagram illustrating a merger of standard and custom generic data mappings capable of being implemented in the system of FIGS. 1-2.

FIG. 15 is a block diagram illustrating a propagation of an update to a standard generic data mapping to a custom generic data mapping in the system of FIGS. 1-2.

FIG. 16 is a block diagram of an exemplary graphical user interface capable of being implemented in the system of FIGS. 1-2.

FIG. 17 is a flowchart illustrating an exemplary routine for publishing a traveler profile in the system of FIGS. 1-2.

### DETAILED DESCRIPTION

Embodiments consistent with the invention provide a dynamic and hierarchical generic data mapping model to facilitate the publication of traveler profile data from a source system, such as a profile management system, to a plurality of downstream target systems. A generic data mapping model consistent with the invention, for example, may be utilized to dynamically build a target-specific publication data mapping, e.g., in association with the publication of profile data from a traveler profile, such that the profile data may be transformed into a target format using the dynamically built publication data mapping.

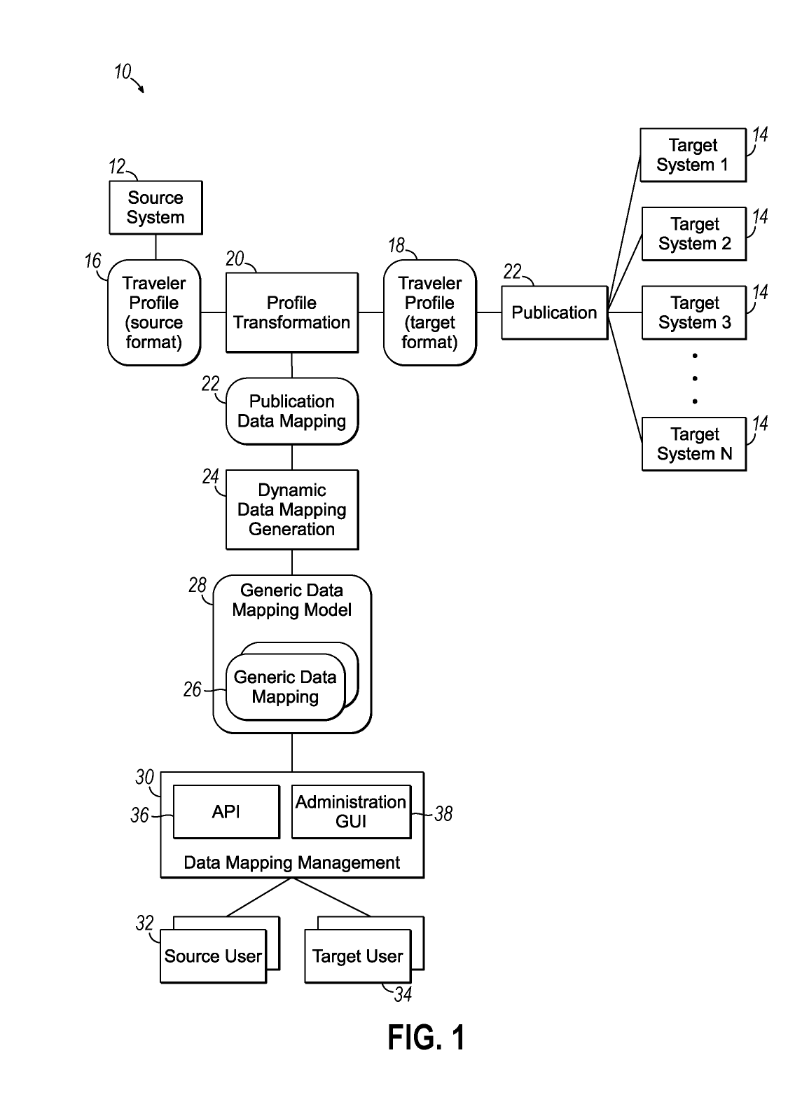

As shown in FIG. 1, for example, a data processing system 10 including a source system 12 and a plurality of target systems 14 may be used to transform profile data configured in a traveler profile in a source format 16 into a target format 18 for the purposes of publishing the traveler profile to a particular target system 14. A source system, in this regard, may be implemented, for example, as a profile management system that operates as a central repository for traveler data, while a target system may be implemented using practically any system desiring to utilize traveler-related data, e.g., computer reservations systems (CRS's), global distribution systems (GDS's), point-of-sales (POS) applications, mid-and-back office applications, self-booking tools (SBT's), etc. Profile data, in this regard, may include various travel-related data, including, for example, data related to a traveler or user of a travel-related web site or service, or other profile-type data otherwise associated with the travel industry. A profile transformation component 20, for example, may be used to transform the traveler profile between the source and target formats, and a publication component 22 may be used to publish the target profile to the appropriate target system 14.

In order to perform a profile transformation using component 20, a publication data mapping 22 is generated by a dynamic data mapping generation component 24 that dynamically generates the publication data mapping 22 from one or more generic data mappings 26 maintained in a generic data mapping model 28. A generic data mapping model in the illustrated embodiments defines a collection of generic data mappings that are utilized to generate publication data mappings. A publication data mapping, in this regard, may be considered to be a data mapping that is capable of being used in association with publishing profile data from a traveler profile from a source system to a target system such that the published profile data can be transformed or converted into a format that is readable by the target system. A publication data mapping may be usable in its native form to transform or convert profile data in some embodiments, or may require additional conversion before transforming profile data. Furthermore, publication of profile data may require additional steps beyond transformation or conversion using a publication data mapping. For example, in some embodiments, profile data may require serialization and deserialization before and after transformation or conversion.

In the embodiments discussed herein, both generic and publication data mappings incorporate one or more mapping elements, with each mapping element defining a relationship between one or more source data elements from the source system and a target data element from the target system. In some embodiments, additional free text may also be incorporated into a mapping element to permit additional text to be incorporated into a target data element based upon target system requirements. Mapping elements may also include groups in some embodiments, permitting groups of source data elements to be omitted from a transformation or conversion when any of the source data elements are not present in the source profile data. In some embodiments, publication and generic data mappings and/or the mapping elements defined therein may be identical to one another, and thus no transformation or conversion may be required to incorporate mapping elements defined in a generic data mapping into a publication data mapping. In other embodiments, however, some transformation or conversion may be required to implement a mapping element defined in a generic data mapping in a format suitable for incorporation into a publication data mapping.

Moreover, a generic data mapping model is both dynamic and hierarchical in nature. A generic data mapping model is dynamic in that publication data mappings may be generated dynamically and on an as-needed basis from the generic data mapping model in association with the publication of profile data from a source system to a particular target system. As opposed to static systems, in which a data mapping required to transform or convert profile data from a source system to a particular target system must be fully defined and deployed prior to a request to publish profile data to the target system, the dynamic nature of the herein-described generic data mapping model permits publication data mappings to be generated on-the-fly whenever a request to publish profile data to a particular target system is received, e.g., in response to a traveler profile being updated in the source system.

A generic data mapping model may be hierarchical in that individual generic data mappings defined by the model may be organized in a hierarchical collection and utilize inheritance to permit descendents/children of other generic data mappings in the hierarchical collection to inherit mapping elements from ancestor/parent generic data mappings in the hierarchical collection. As will become more apparent below, for example, generic data mapping may be defined for particular countries, geographical regions, corporations, organizations, etc., and related hierarchically so that the creation of a generic data mapping for a particular target system need not start from scratch, but may instead represent additions or modifications to other generic data mappings. Some generic data mappings may be global, for example, while others may be organization-specific or region-specific.

In order to create, edit, delete and otherwise manage the data mappings utilized in the transformation of profiles into target formats, system 10 also includes a data mapping management component 30 accessible to both source users 32 and target users 34, e.g., via an Application Programming Interface (API) 36 and/or an administration GUI 38 such as a web-based GUI. As will become more apparent below, by providing access to data mapping management component 30 by target users 34, much of the overhead associated with managing target-specific transformations may be handled by the target entities, rather than requiring the source entity to manage the transformations for all of the target systems.

Additional details regarding the profile transformation and publication processes will be described in greater detail below.

### Hardware and Software Environment

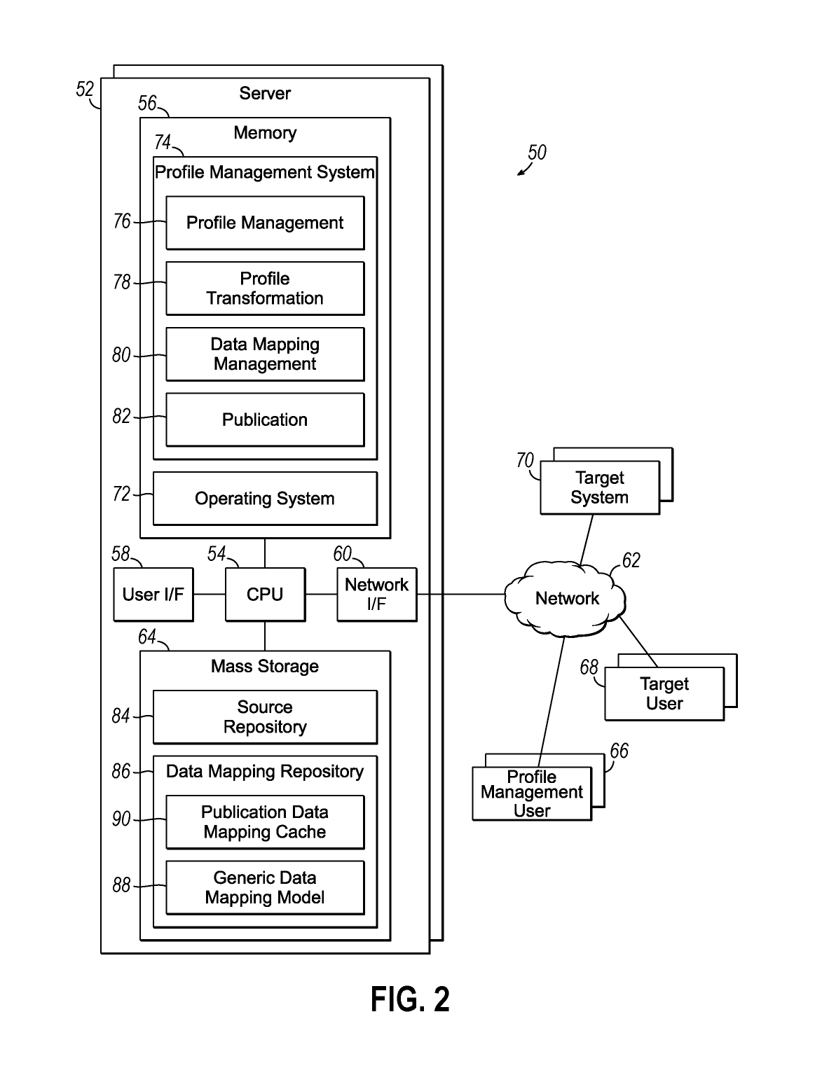

FIG. 2 illustrates an exemplary hardware and software environment for a data processing system 50 in which a dynamic and hierarchical generic data mapping model may be implemented. System 50 may be implemented by one or more server-type computers 52, e.g., multiple computers coupled to another in a clustered or other distributed architecture. Each computer 52 typically includes a central processing unit 54 including at least one hardware-based microprocessor coupled to a memory 56, which may represent the random access memory (RAM) devices comprising the main storage of computer 52, as well as any supplemental levels of memory, e.g., cache memories, non-volatile or backup memories (e.g., programmable or flash memories), read-only memories, etc. In addition, memory 56 may be considered to include memory storage physically located elsewhere in computer 52, e.g., any cache memory in a microprocessor, as well as any storage capacity used as a virtual memory, e.g., as stored on a mass storage device or on another computer coupled to computer 52. Computer 52 also typically receives a number of inputs and outputs for communicating information externally. For interface with a user or operator, computer 52 typically includes a user interface 58 incorporating one or more user input devices, e.g., a keyboard, a pointing device, a display, a printer, etc. Otherwise, user input may be received via another computer or terminal, e.g., over a network interface 60 coupled to a network 62 such as the Internet. Computer 52 also may be in communication with one or more mass storage devices 64, which may be, for example, internal hard disk storage devices, external hard disk storage devices, external databases, storage area network devices, etc.

Various external devices may be coupled to system 50 over network 62, e.g., one or more source or profile management users 66, one or more target users 68 and one or more target systems 70.

Each computer 52 typically operates under the control of an operating system 72 and executes or otherwise relies upon various computer software applications, components, programs, objects, modules, data structures, etc., e.g., a profile management system 56 including various components such as a profile management component 76, a profile transformation component 78, a data mapping management component 80 and publication component 82, a source repository 84, and a data mapping repository 86 including a generic data mapping model 88 and publication data mapping cache 90, as will be described in greater detail below. Moreover, various applications, components, programs, objects, modules, etc. may also execute on one or more processors in another computer coupled to computer 52 via a network, e.g., in a distributed or client-server computing environment, whereby the processing required to implement the functions of a computer program may be allocated to multiple computers over a network. For example, some of the functionality described herein as being incorporated into a computer 52 may be implemented in a target system, a source or target client computer, or other external device.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by computer 52. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIGS. 1 and 2 is not intended to limit the present invention. Indeed, those skilled in the art will recognize that other alternative hardware and/or software environments may be used without departing from the scope of the invention.

### Dynamic and Hierarchical Generic Data Mapping Model

In the embodiment discussed hereinafter, a flexible, generic data mapping (GDM) model is utilized to provide a target independent data mapping definition that is readily adapted to different types of data models (e.g., for both structured and unstructured downstream/target systems), and represented in a logical and human understandable view to reduce the skill set required to view and the manage data mappings used to transform profile data into a particular target format.

In the embodiment discussed hereinafter, a GDM incorporates a plurality of mapping elements, also referred to herein as lines, which define the relationship between a data element of a target/downstream system (e.g., a target profile field) and one or more source data elements (e.g., source profile fields and any free text). In other words, within a mapping element or line, a target profile field may be mapped to any combination of source profile fields and free text.

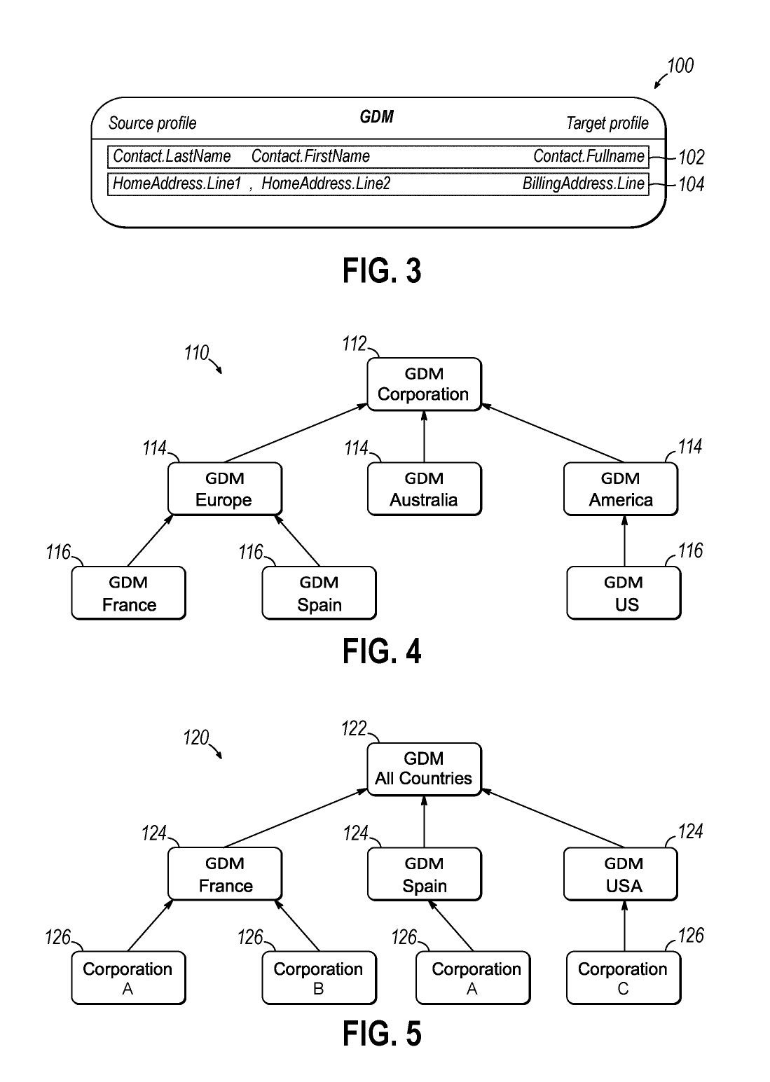

FIG. 3, for example, illustrates an exemplary GDM 100 including two mapping element 102, 104. Mapping element 102 maps a target field “Contact.FullName” with source fields “Contact.LastName” and “Contact.FirstName” along with a space character as additional free text (i.e., the two fields are concatenated and separated by a space “ ”). Mapping element 104 maps the concatenation of source field “HomeAddress.Line1”, the comma free text “,”, and source field “HomeAddress.Line2” to target field “BillingAddress.Line”.

It has been found that data mapping is often not straightforward, and that several operations may need to be applied on source or target fields to fit the constraints of target/downstream systems. Moreover, in some instances, a line or mapping element may be valid only under a certain context. Thus, to allow flexibility and allow a more refined mapping, a GDM model consistent with the invention may be enriched with several features:

Grouping: groups of source data elements (source profile fields and free text may be defined. By doing so, source data elements may be bound to one another, so that if a profile field is not present in a particular traveler profile, then the entire group of source data elements may be discarded. For example, groups may be defined using special delimiters (e.g., “{” and “}” so that if a target field for “Name” is mapped to a group of source data elements defined as “{LastName}{/FirstName}”, the free text “/” may be omitted if the “FirstName” profile data is missing in the published traveler profile. Furthermore, grouping may allow for the definition of common attributes (macros) for a group. In addition, if a mandatory element of a group is not present, the entire group may be discarded and omitted from the published profile.

Macros: it may be desirable to define custom macros per group/source profile field to allow specific data transformations (e.g., data truncations, data translations, data splits, etc.)

Discardable lines: it may be desirable to discard a line if a source profile field or a group of source data elements is empty. For example, a target field “Name” mapped to “{LastName}{/FirstName}” may be discarded if “LastName” is empty.

Mandatory lines: it may be desirable to always generate a line even if the source data fields mapped to a target field are empty. This may be useful, for example, to remind a travel agent to get some information about a traveler.

As also noted above, a GDM model consistent with the invention is also hierarchical in nature, which minimizes data redundancy and otherwise facilitates management of a large number of data mappings utilized for disparate target systems. A GDM is permitted to inherit from another GDM and effectively “customize” the other GDM by following predetermined inheritance rules. The inheriting GDM, also referred to herein as a child or descendent GDM, may be defined using only the mapping elements that have been customized, with any inherited mapping elements from a parent or ancestor GDM being defined in the parent/ancestor GDM.

As such an entity such as a travel retailer may only be required to define a complete data mapping for a global or default GDM, and then whenever a new data mapping is required (e.g., for a new deployment), the entity would only need to choose the appropriate GDM from the defined hierarchy and create a new GDM inheriting from the one chosen previously, by customizing only the desired lines.

In the illustrated embodiment, a hierarchy of GDM's may be specific per downstream/target system. In other embodiments, however, all GDM's for a particular target system may inherit from one or more master GDM's that are target-independent.

GDM's related via inheritance may be considered to be a hierarchical collection of GDM's, and may be represented, for example, by a tree. For example, FIG. 4 illustrates an example GDM hierarchical collection 110 that captures geographical specificities for a particular corporation or organization, whereby a master corporation-wide GDM 112 is defined and modified for particular geographical regions, e.g., using one or more region-specific GDM's 114, and within each region, one or more country-specific GDM's 116. Alternatively, as illustrated in FIG. 5, a GDM hierarchical collection 120 may include a master country- and corporation-independent GDM 122, which is then modified for different geographical regions by GDM's 124 and further modified for particular corporations by GDM's 126.

By providing inheritance, new deployments often require only customizable target fields in exiting GDM's to be redefined or extended. Furthermore, from the perspective of maintenance of existing hierarchies, an update to a common field in one GDM that is inherited by multiple GDM's typically does not require updates to multiple, individual GDM's.

To support inheritance, it may be desirable to provide constraints on what mappings may be inherited and/or customized. For example, in the illustrated embodiment lines or mapping elements may be defined as either read-only lines, which may not be changed by an inheriting GDM (thereby ensuring coherence for most important target fields, and inhibiting the removal of mandatory target fields), or customizable lines, which may be defined by a parent GDM and opened to customization by a child GDM (e.g., either the entire line can be customized, or only some parts of the line can be customized).

Thus, in the illustrated embodiment, a new GDM, which inherits from a parent GDM, may be permitted to modify customizable lines of its parent, parent of the parent, etc, by changing the type of the line (e.g., converting a customizable line to a read-only line), changing the customizable content (e.g., the entire line or some parts of the line), changing line attributes, or adding new lines corresponding to target fields not already mapped in parent lines, parent of the parent lines, etc.

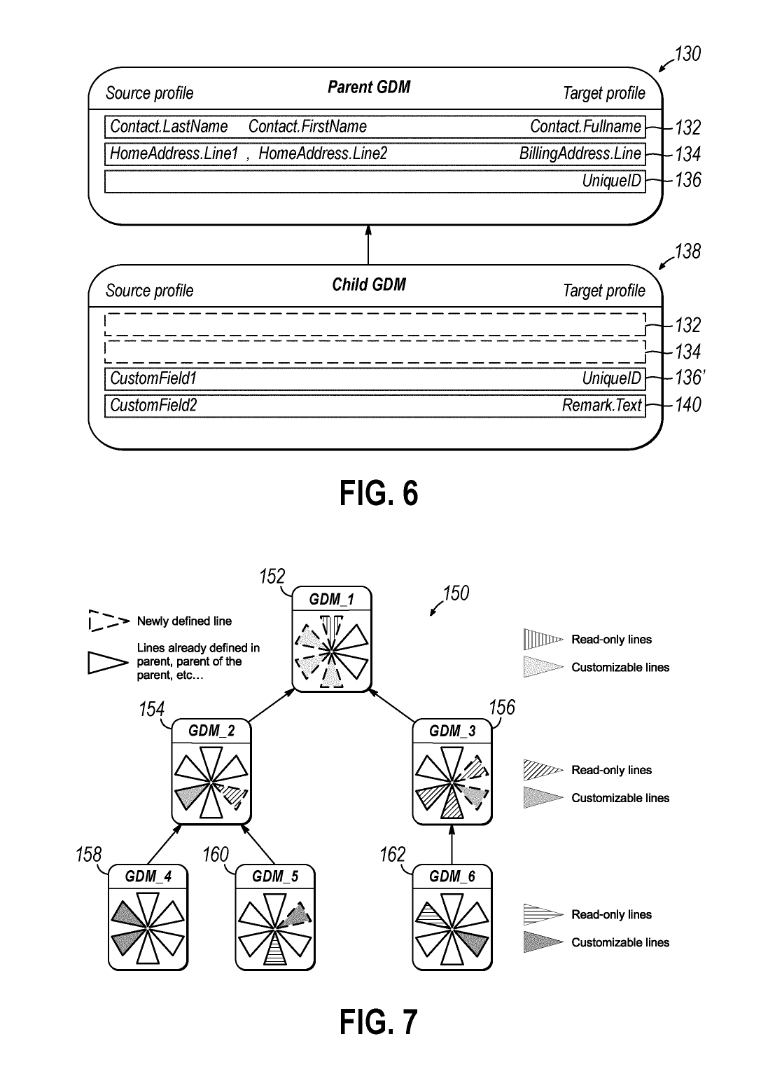

For example, FIG. 6 illustrates a hierarchy including a parent GDM 130, which includes two read-only-lines 132, 134 (for target fields Contact.FullName and BillingAddress.Line), and one customizable line 136 (for target field UniqueID). A child GDM 138 fills the customizable line (represented at 136′) by mapping CustomField1 to UniqueID, and adds a new line 140, which maps CustomField2 to a Remark field. Likewise, FIG. 7 illustrates a more complex hierarchy 150, including six GDM's 152-162.

To reduce risk of errors (i.e. a target field, which has a unique occurrence in the profile, being mapped twice), it may be desirable to perform consistency checking of an inheritance hierarchy whenever a GDM is created or updated. Doing so desirably minimizes profile rejections during publication. Thus, for example, in response to creation/update of a GDM, upper GDM's in the hierarchy (the parent GDM, the parent of the parent, etc.) may be analyzed to detect if any inheritance rules are not fulfilled, causing the creation/update is rejected. In addition, for lower GDM's in the hierarchy (all the GDM's that inherit from this GDM or from a GDM inheriting itself from this GDM, etc.) updates may be automatically and dynamically propagated to the inheriting GDM's, whereby the inhering GDM's are also updated in order to fulfill the inheritance rules. Thus, for example, if a new line that maps the target field remark in a GDM is added, then all the inheriting GDM's that have already mapped this target field, may lose this particular line.

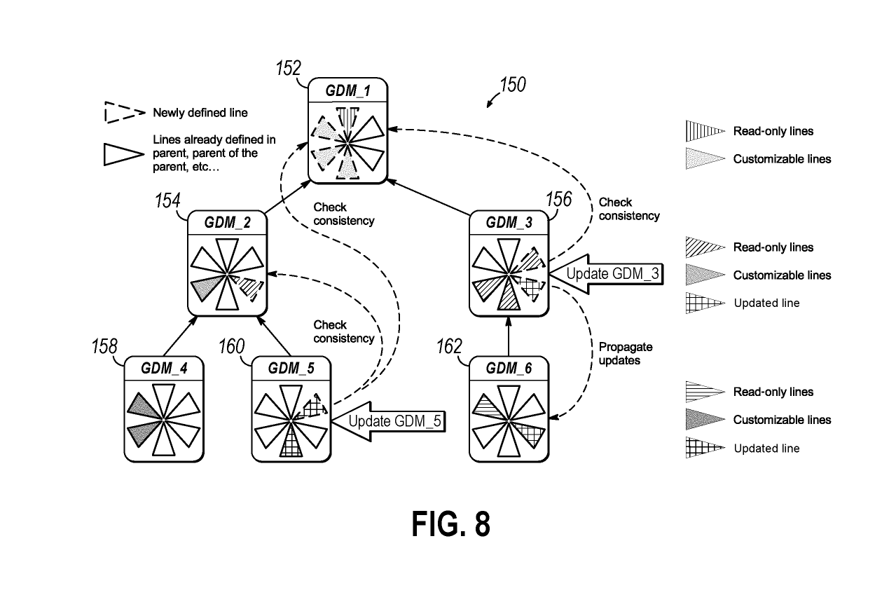

As shown in FIG. 8, for example, an update to GDM 156 requires consistency be checked with parent GDM 152, and results in an updated line being propagated to GDM 162. Likewise, an update to GDM 160 requires that consistency be checked with both parent GDM 154 and grandparent GDM 152.

In addition, as also noted above, a GDM model consistent with the invention also supports dynamic generation of data mappings for use during publication of a traveler profile to a specific target system. In particular, in the illustrated embodiment, with a consistent hierarchical GDM model defined, the specific GDM to be used during a publication may be computed based on the lines or mapping elements of the GDM as well as the lines or mapping elements of any ancestor GDM's. The specific GDM typically will be the addition of the read-only lines of the parent, of the parent of the parent, etc., the customizable lines redefined in the specific GDM, and the customizable lines redefined in the parent and not redefined in its child, the customizable lines redefined in the parent of the parent and not redefined in the child, etc. In addition, due to the aforementioned inheritance rules and dynamic consistency process, the merging process may typically be performed without any conflicts and without any need to further check consistency in the GDM hierarchy, thereby facilitating the dynamic generation of the specific GDM.

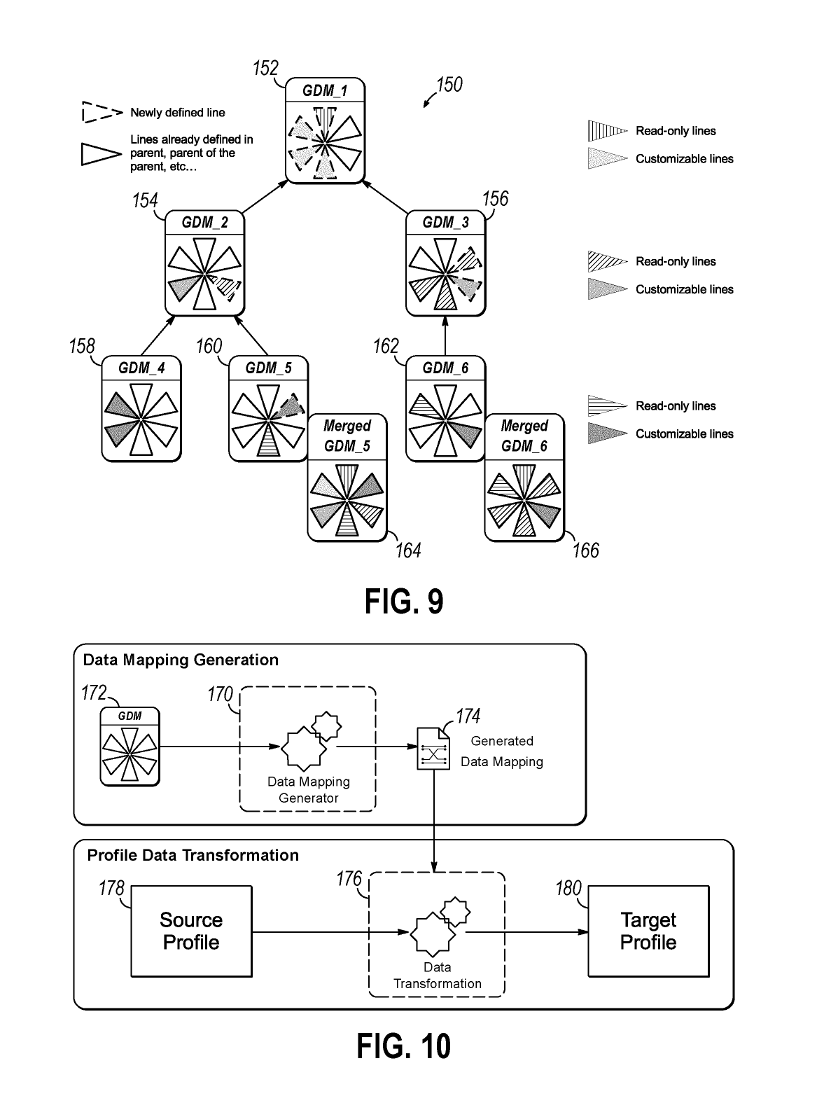

FIG. 9, for example, illustrates a merged GDM 164 generated from GDM 160, incorporating lines or mapping elements from ancestor GDM's 152, 154, and a merged GDM 166 generated from GDM 162, incorporating lines or mapping elements from ancestor GDM's 152, 156.

It will be appreciated that various features of the herein-described hierarchical and dynamic generic data mapping model may be omitted in some embodiments, and that additional features may be incorporated without departing from the spirit and scope of the invention. Therefore, the invention is noted limited to the particular generic data mapping model disclosed herein.

### Interactive Management

Due to the extensible and target-independent nature of the herein-described generic data mapping model, management of GDM's is often simple and intuitive enough to be performed by non-technical users, e.g., target system personnel. For example, it may be desirable to support a GDM web service to permit users to create, retrieve, update, delete and search GDM's defined by a generic data mapping model, e.g., by non-technical travel agents.

In addition, embodiments consistent with the invention support use of a GDM in a publication process as soon as it is created or modified, resulting in the on-demand generation of a publication data mapping from a GDM, typically without the need for human intervention. For example, FIG. 10 illustrates a dynamic generation of a publication data mapping, also referred to herein as a generated data mapping, from a GDM. In particular, a data mapping generator component 170 accesses a GDM 172 associated with the target system and generates therefrom a generated or publication data mapping 174 suitable for use by a data transformation component 176 to transform profile data from a source profile 178 into a target profile 180. It should be noted that the GDM may be considered to be more of a logical view of a data mapping, whereas the generated or publication data mapping may be considered to be more of a specific view of a data mapping specifically adapted for use in a downstream publication system. As such, generation of a publication or generic data mapping may require additional operations, e.g., to generate a data mapping suitable for use in the downstream publication system.

Moreover, in order to ensure that modifications made to a GDM are immediately available, it may be desirable to generate publication data mappings dynamically and on-the-fly, e.g., every time a publication data mapping is used. For example, in some embodiments, publication of a profile may be performed any time data in a profile is updated on the source system, e.g., to ensure that all downstream/target systems receive the updates to the profile in a timely manner.

In some embodiments, e.g., where profiles are published frequently, dynamically generating a publication data mapping in association with each profile publication may present significant system overhead. In such instances, it may be desirable to additionally include a caching mechanism to cache previously-generated publication data mappings and thereby permit their reuse upon subsequent profile publications. Through the use of a caching mechanism, a publication data mapping may need to be generated only when the associated GDM, or one of its ancestors, has changed since the last usage of the publication data mapping.

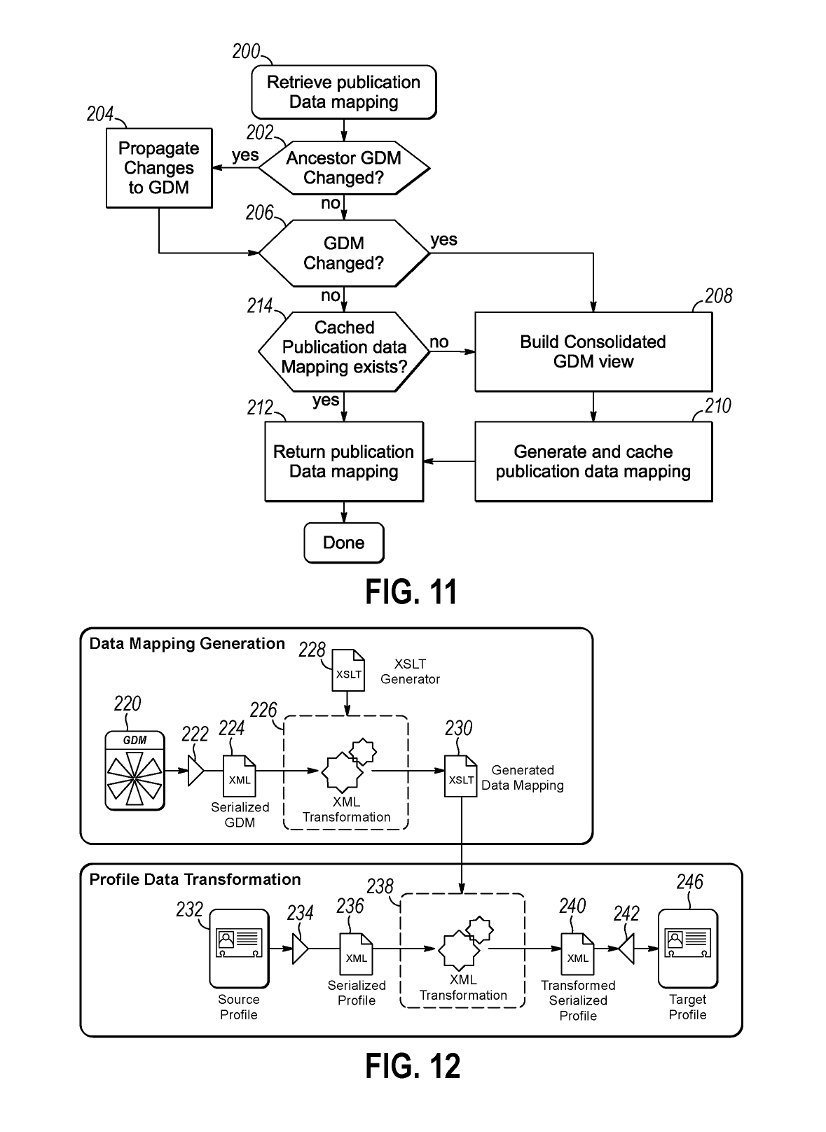

FIG. 11, for example, illustrates a data mapping generation routine 200 that may be executed in response to a request to retrieve a publication data mapping for a particular GDM (e.g., in association with the publication of a profile utilizing the GDM). First, in block 202, a determination is made as to whether any ancestor GDM for the referenced GDM has changed. If so, control passes to block 204 to propagate the changes to the referenced GDM. Thereafter, or if no changes were detected in block 202, control passes to block 206 to access the referenced GDM and determine whether any changes to the referenced GDM have occurred. If so, control passes to block 208 to build a consolidated (or merged) GDM view, and then to block 210 to generate the publication data mapping from the consolidated GDM view and store the publication data mapping in a cache. Control then passes to block 212 to return the generated publication data mapping in response to the request, and routine 200 is complete.

Returning to block 206, if the GDM is determined to have not changed, control passes to block 214 to determine whether a cached version of the publication data mapping corresponding to the referenced GDM is currently cached. If not, control passes to block 208 to generate the publication data mapping. Otherwise, block 214 passes control to block 212, which returns the cached copy of the publication data mapping in response to the request.

Therefore, whenever a change occurs to a GDM, any cached copy of the corresponding publication data mapping will be discarded and replaced with a newly generated publication data mapping. It will be appreciated that a cache may also have a limited size, and as such, publication data mappings may not exist in a cache if they have been cast out as a result of other publication data mappings being added to the cache since the last time the cast-out publication data mappings were used.

The aforementioned dynamic and hierarchical generic data mapping model may be implemented in a number of different manners consistent with the invention. For example, in one implementation highlighted hereinafter, profile data transformation may be performed by applying an XML (Extensible Markup Language) transformation with an XSLT (Extensible Stylesheet Language Transformation) processor on an XML serialized form of a traveler profile. Thus, a publication data mapping may be implemented as an XSLT stylesheet generated from a GDM.

As shown in FIG. 12, for example, publication of a profile may incorporate serializing a GDM 220 with a serializer 222 to generate a serialized GDM 224. An XML transformation is then performed at 226 using an XSLT generator 228 to generate a publication or generated data mapping 230 having the form of an XSLT stylesheet. The XSLT generator itself is a stylesheet capable of transforming the XML serialized GDM 224 into an XSLT stylesheet 230 used for data mapping.

Next, during publication of a source profile 232, the source profile is serialized by a serializer 234 to generate a serialized profile 236, and an XML transformation is then performed at 238 using the publication data mapping 230 to generate a transformed serialized profile 240. A deserializer 242 then deserializes the profile, resulting in a target traveler profile 246.

Typically, few XSLT generator stylesheets are needed to generate as many data mappings, as the number of XSLT generator stylesheets does not depend on the volume of data mapping. Thus it is often sufficient to write and maintain such stylesheets manually. It will also be appreciated that the generation of XSLT generator stylesheets suitable for generating XSLT-format publication data mappings from the GDM's described herein would be well within the abilities of one of ordinary skill in the art having the benefit of the instant disclosure.

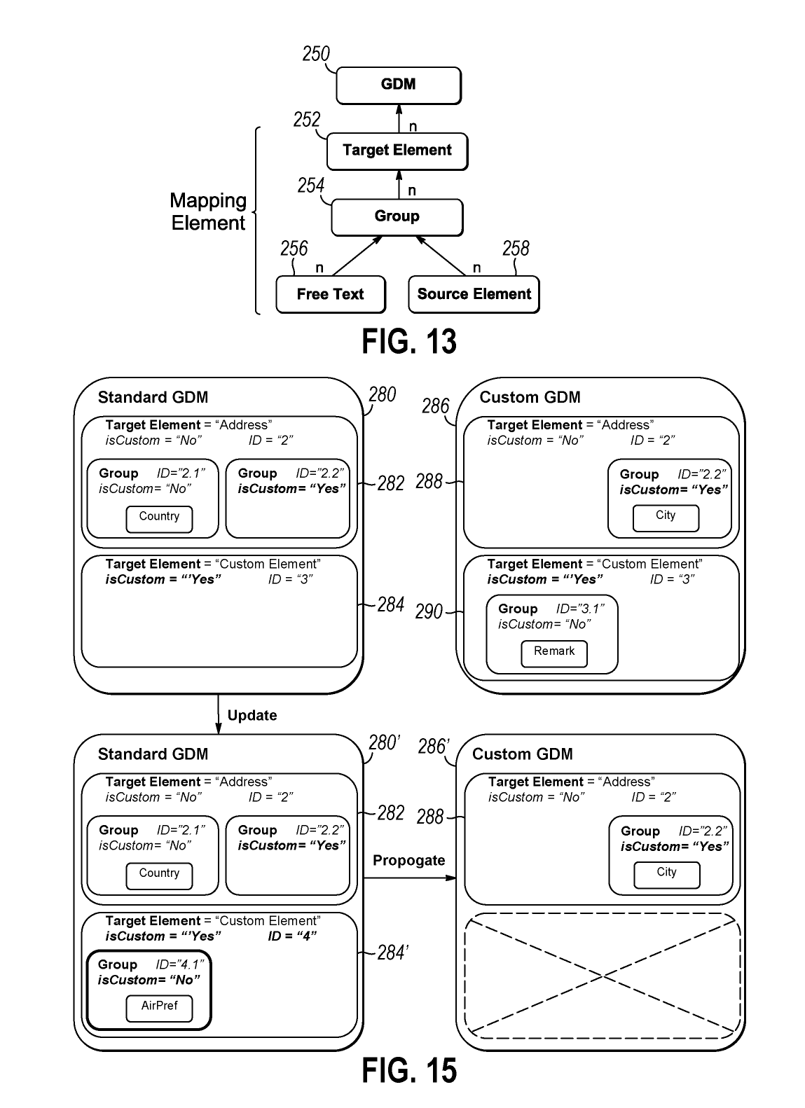

A GDM in this implementation may incorporate an object model as defined in FIG. 13, whereas a GDM 250 includes a plurality of target data elements 252, each associated with one or more groups 254, each including one or more free text elements 256 and source data elements 258. These elements combine to form one or more mapping elements or lines that map a target field reference to one or more source field references with various bindings, groupings and transformations as desired for a particular target system. A group in this implementation is a mixed sequence of free text and source field references, and grouping source data has an impact on the result of the data mapping such that if one source field of the group is undefined the whole group is discarded.

The same object model is used for all the different representations needed for administration services and publication process, including structured data in memory, XML documents and persistent storage. In addition, for this implementation the hierarchical collection of GDM's form an inheritance tree with two levels to match both corporation and geographical specificities. At the first level are standard GDM's that are customizable and specific to one market (e.g., geographical region), and at the second level are custom GDM's that inherit from one standard GDM and fill the customizable parts to apply to the traveler profiles of a single corporation.

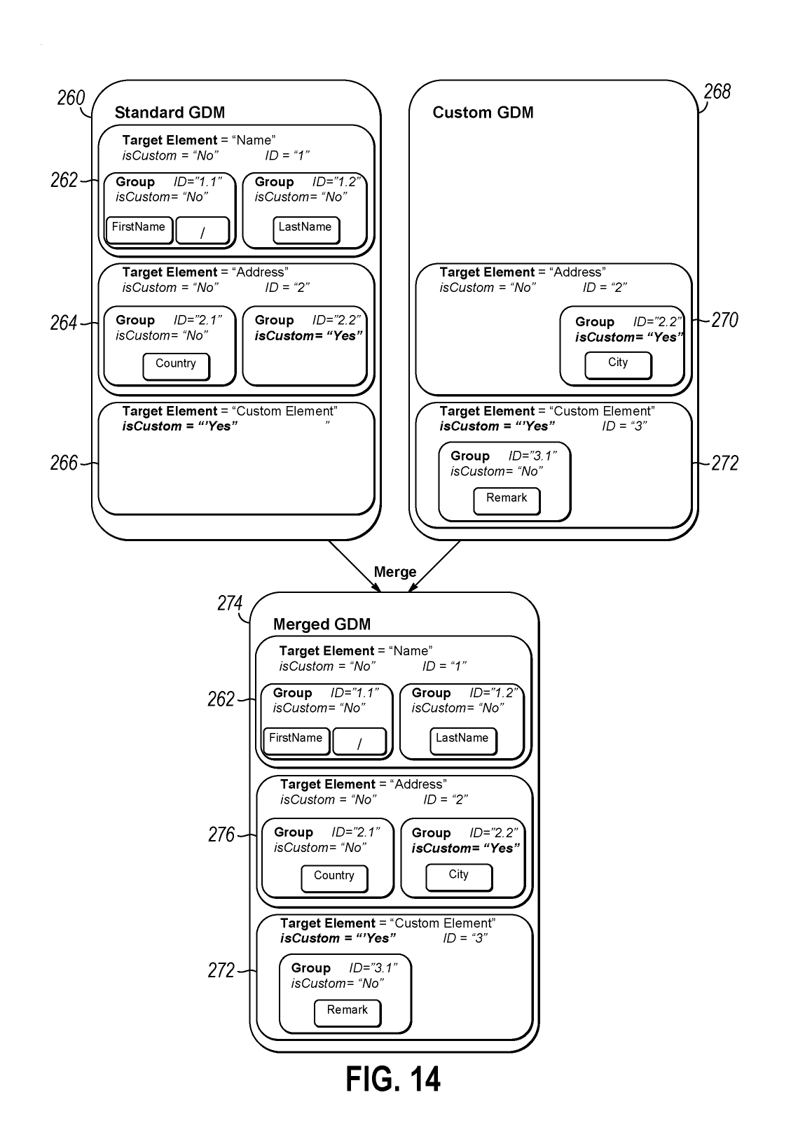

Customization is permitted in this embodiment at two levels. First, at line or mapping element level, and at group level. In the latter level, a complete-able line may be considered to include one or more customizable groups. To identify if a line or a group are customizable, a special attribute, is Custom, may be used. If this special attribute is set to False, the line/group is not modifiable, and every modification in that case will be rejected by the server. For a custom line, the is Custom attribute is defined at line level, and for a complete-able line, the is Custom attribute is defined at group level. For example, as shown in FIG. 14, a standard GDM 260 may be defined with three mapping elements 262, 264 and 266. Mapping element 262 is read-only, and used to map a traveler name, and includes two groups, one for a concatenation of a first name and the “/” character, and one a last name. Mapping element 264 is a complete-able line and includes one read-only group for country, and one customizable group, which as illustrated by custom GDM 268 and mapping element 270 may be customized to include a city. Mapping element 266 is a custom line which may be customized as illustrated by mapping element 272 of GDM 268 to include a remark group.

In this embodiment, ensuring consistency of a custom GDM may include verifying that the custom GDM has defined only the custom lines or complete-able lines of the standard GDM. In addition, to facilitate finding correspondence between the lines in a standard GDM and lines in a custom GDM, a unique identifier (or a tattoo) may be assigned to each line and to each group by the publication framework at creation/update time. Hence, as illustrated in FIG. 14, a custom GDM may specify the identifier (ID) of the lines or groups that it redefines.

Thus, based on the line and group identifiers, the validation of a custom GDM may be relatively straightforward. For example, the custom GDM may be determined to be valid if the line/group identifiers it defines are already present in the standard GDM and these identifiers correspond only to customizable lines/groups.

Automatic computation of a generic data mapping to be used in a publication may rely on the consistency of the hierarchy and on the line/group identifiers. In particular, and as also shown in FIG. 14, a merged GDM 274 may include all the lines/groups defined in custom GDM 268 and all the lines/groups defined in standard GDM 260 and not already defined in custom GDM 268. Thus, merged GDM 274 may include mapping element 262 from standard GDM 260 and overriding mapping element 272 from custom GDM 268, as well as a merged mapping element 276 generated from the customization of mapping element 264 by mapping element 270.

In order to propagate updates from a standard GDM to a custom GDM, it may be necessary to discard mapping elements from a custom GDM in order to maintain consistency. For example, as shown in FIG. 15, where a standard GDM 280 includes an unchanged mapping element 282 and a mapping element 284 that is overridden by a custom GDM 286 having overriding mapping elements 288, 290, a modification to mapping element 284 (illustrated by mapping element 284′ of standard GDM 280′) may cause mapping element 290 of custom GDM 286 to be discarded, as illustrated at 286′.

This operation may also be implemented based on identifiers. For example, when a standard GDM is being updated, line/group identifiers may be preserved if the line/group has not changed (as with mapping element 282). In addition, line/group identifiers may be regenerated if the line/group has changed (as with mapping element 284′). Likewise, for the propagation of an update to a standard GDM to a custom GDM, if a line/group identifier does still exist in the standard GDM, then the line/group is preserved (as with mapping element 288), and if a line/group identifier does not exist anymore in the standard GDM (meaning that the line/group has been modified or deleted), then the line/group is not preserved in the custom GDM (as with mapping element 290).

In order to delegate data mapping deployment and maintenance to a target entity or customer, web services interfaces may be used to offer remote operations such as Create/Update/Delete of standard generic data mapping, Create/Update/Delete of custom generic data mapping, List existing standard GDM's associated with a given market, List existing custom GDM associated with a given corporation and optionally a market. The web services may also include a graphical interface for publication administration. Thus, a customer or target entity may itself manage generic data mappings and control profile publication.

Web services may be hosted, for example, by an administration server that interacts with a persistent storage holding the GDM's created by end-users. A publication system may have access to the same persistent storage to extract the GDM's from which are generated the corresponding publication data mappings (see, e.g., FIG. 1, data mapping management component 30, which provides both an API 38 to support direct remote calls, and administration GUI 38, which supports a web-based administration GUI).

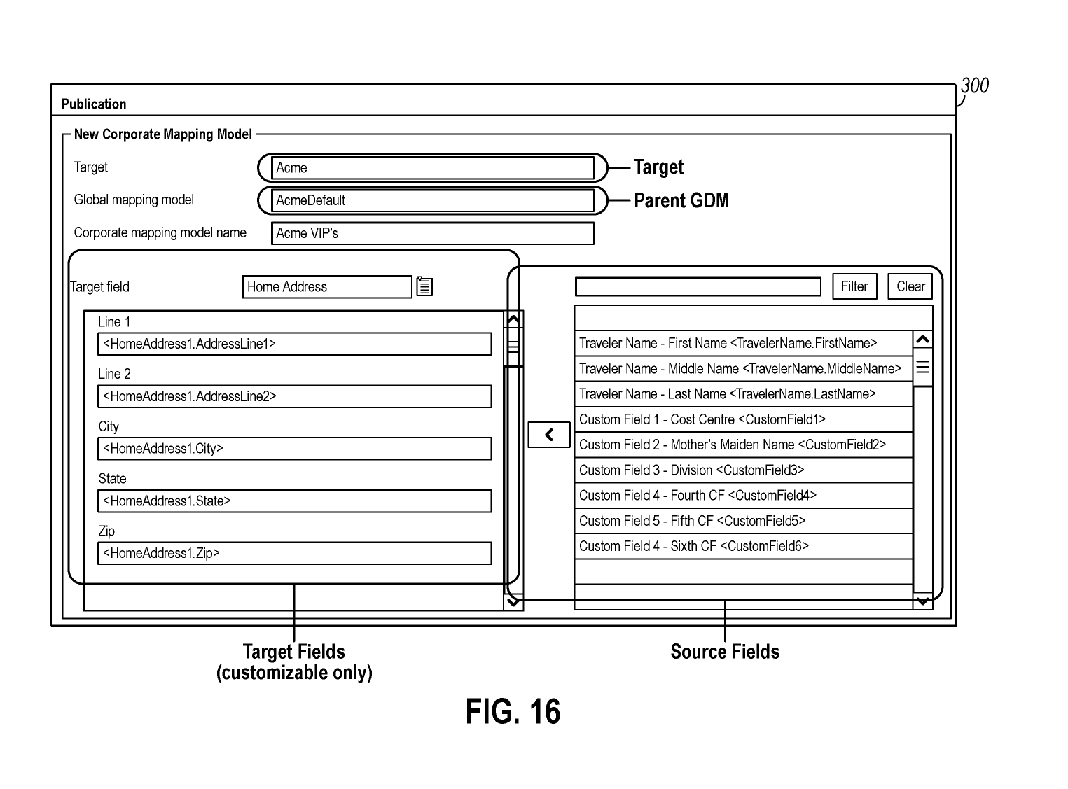

Web services may use an XML format to exchange messages between clients and the server. The XML format may follow the same structure as the GDM model presented above. An exemplary web interface is further illustrated at 300 in FIG. 16, and includes controls for entering a target identifier, a parent GDM identifier, and a customizable GDM identifier, and controls for selecting and mapping target and source fields.

As with the other embodiments described above, updates from standard/custom GDM's may be taken into account instantaneously in the publication framework. While in some embodiments, data mappings may be regenerated each time a standard/custom GDM is modified, if a standard GDM has a considerable number of custom GDM's inheriting from it, the delay of updating all custom GDM's may be significant, and profile publication arriving during this delay may not be guaranteed to use the latest GDM without additional safeguards put into place.

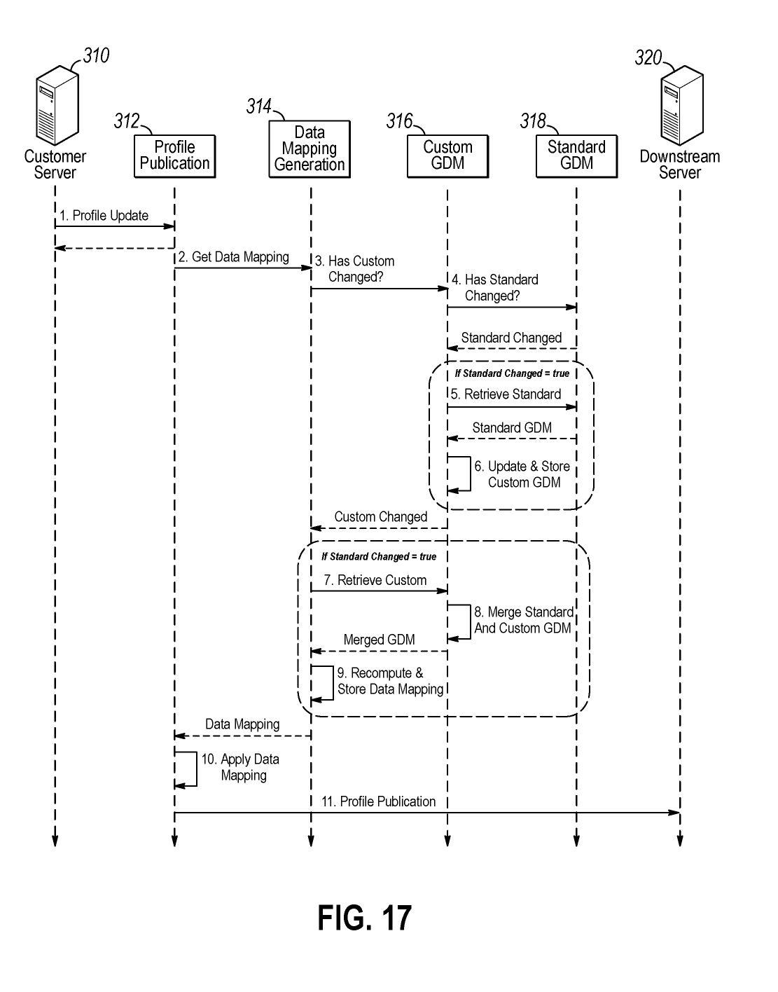

Therefore, in this implementation, it is desirable to generate data mappings dynamically and on-the-fly at publication time as shown in FIG. 17. Specifically, in response to an update to a traveler profile by a customer server 310 (step 1), a profile publication component 312 may, first, confirm the update to the profile to the requester, and second, request a publication data mapping from a data mapping generation component 314 (step 2). Component 314 determines whether a custom GDM 316 for a target system 320 has changed (step 3), which in turn determines whether a standard GDM 318 upon which it is based has changed (step 4).

If standard GDM 318 has changed, this information is conveyed back to custom GDM 316, which then retrieves the new standard GDM (step 5) and updates and stores the updated custom GDM (step 6). Custom GDM 316 then responds to component 314 indicating the changed status, and component 314 retrieves the new custom GDM (step 7), which is handled by the custom GDM by merging the standard and custom GDM's and returning a merged GDM to component 314 (step 8). Component 314 then recomputes and stores a publication data mapping and returns the publication data mapping to profile publication component 312 (step 9). Component 312 then applies the data mapping to the updated profile to transform the updated profile to the target format (step 10), and publishes the updated profile to the downstream target system 320 (step 11).

The aforementioned implementation may be used, for example, to enable multiple travel retailers, e.g., travel agencies, to provide travel services to traveling employees, or travelers, on behalf of various corporations employing the travelers. In this regard, travel retailer users, many of which may not be technologically sophisticated, may be provided with a relatively simple and intuitive interface that enables data mappings to be created and updated for various downstream systems by the travel retailers themselves. It will be appreciated, however, that the invention may be utilized in connection other travel-related services for which it is desirable to publish profile data from a central repository to various downstream systems. Therefore, the invention is not limited to the particular applications disclosed herein.

Other modifications will be apparent to one of ordinary skill in the art having the benefit of the instant disclosure. Therefore, the invention lies in the claims hereinafter appended.

What is claimed is:

1. A method of updating a traveler profile, the method comprising:
updating a traveler profile in a source system, wherein the source system stores profile data for travelers in a source format; and
in response to updating the traveler profile, publishing the traveler profile to a target system from among a plurality of target systems coupled to the source system, wherein the target system stores profile data for travelers in a target format, and wherein at least one of the plurality of target systems is selected from the group consisting of a global distribution system (GDS) and a self-booking tool (SBT) system, wherein publishing the traveler profile comprises:
determining whether an unchanged publication data mapping for use in publishing the updated traveler profile to the target system is cached;
if an unchanged publication data mapping for use in publishing the updated traveler profile is cached, converting the traveler profile from the source format to the target format for the target system using the unchanged publication data mapping; and
if an unchanged publication data mapping for use in publishing the updated traveler profile is not cached, dynamically generating a publication data mapping and converting the traveler profile from the source format to the target format for the target system using the dynamically generated publication data mapping, wherein the dynamically generated publication data mapping is configured to convert source profile data from the source system and for a traveler into target profile data associated with first and second target data elements for the target system based upon first and second mapping elements respectively defined in first and second generic data mappings in a hierarchical collection of generic data mappings, wherein the hierarchical collection of generic data mappings defines a plurality of mapping elements including the first and second mapping elements, wherein each mapping element in the plurality of mapping elements defines a relationship between at least one source data element from the source system and a target data element from the target system, wherein the first mapping element is defined in the first generic data mapping and maps at least one source data element to the first target data element, wherein the first generic data mapping is a descendent of the second data mapping, wherein the second mapping element is defined in the second generic data mapping and maps at least one source data element to the second target data element, and wherein the first generic data mapping inherits the second mapping element from the second generic data mapping element.

2. A method of generating a publication data mapping for use in publishing traveler profile data from a source system to a target system from among a plurality of target systems, the source system configured to store profile data for a plurality of travelers, the method comprising:
accessing a first generic data mapping associated with the target system from a hierarchical collection of generic data mappings, wherein the hierarchical collection of generic data mappings defines a plurality of mapping elements, wherein each mapping element in the plurality of mapping elements defines a relationship between at least one source data element from the source system and a target data element from the target system, wherein the first generic data mapping defines a first mapping element that maps at least one source data element to a first target data element, and wherein the first generic data mapping is a descendent of a second data mapping in the hierarchical collection of generic data mappings, wherein the second generic data mapping defines a second mapping element that maps at least one source data element to a second target data element, and wherein the first generic data mapping inherits the second mapping element from the second generic data mapping; and
dynamically generating the publication data mapping based at least upon the first and second generic data mappings, the publication data mapping configured to convert source profile data from the source system and for a traveler into target profile data associated with the first and second target data elements for the target system based upon the first and second mapping elements defined in the first and second generic data mappings.

3. The method of claim 2, further comprising converting source profile data from the source system and for the traveler into target profile data for the target system using the publication data mapping.

4. The method of claim 3, wherein dynamically generating the publication data mapping is performed in response to updating a source profile for the traveler in the source system.

5. The method of claim 4, wherein converting the source profile data comprises converting the source profile to a target profile, wherein the publication data mapping comprises an XSLT stylesheet and wherein the source and target profiles each comprise an XML document.

6. The method of claim 3, wherein the first mapping element comprises a group that binds first and second source data elements from the source system to the first target data element, and wherein converting the source profile data into target profile data includes discarding source profile data associated with the second source data element in response to determining that no source profile data associated with the first source data element exists.

7. The method of claim 3, wherein the first mapping element comprises a group that binds a first source data element from the source system and free text to the first target data element from the target system, and wherein converting the source profile data into target profile data includes discarding the free text in response to determining that no source profile data associated with the first source data element exists.

8. The method of claim 2, wherein the source profile data is associated with a profile for the traveler, the method further comprising:
publishing the profile by communicating the target profile data to the target system;
caching the publication data mapping after dynamically generating the publication data mapping; and
reusing the publication data mapping to publish a second profile in response to determining that the publication data mapping is cached.

9. The method of claim 2, wherein the source profile data is associated with a profile for the traveler, the method further comprising:
publishing the profile by communicating the target profile data to the target system;
caching the publication data mapping after dynamically generating the publication data mapping; and
dynamically regenerating the publication data mapping in association with publishing a second profile in response to determining that at least one generic data mapping used to dynamically generating the publication data mapping has changed.

10. The method of claim 2, wherein the second generic data mapping includes a third mapping element, and wherein the first mapping element overrides the third mapping element.

11. The method of claim 2, wherein the second mapping element is read-only such that overriding of the second mapping element mapping element in the first generic data mapping is prohibited.

12. The method of claim 2, wherein each generic data mapping in the hierarchical collection is selected from the group consisting of a global generic data mapping, an organization-specific generic data mapping and a region-specific generic data mapping.

13. The method of claim 2, further comprising updating at least one of the first and second generic data mappings in response to input received from a user associated with the target system.

14. The method of claim 13, wherein updating at least one of the first and second generic data mappings is performed via a web interface.

15. The method of claim 13, further comprising automatically propagating a change made when updating the second generic data mapping to the first generic data mapping based upon the first generic data mapping being a descendent of the second generic data mapping.

16. The method of claim 15, wherein automatically propagating the change is performed in response to a request to publish a profile using a publication data mapping based upon the first generic data mapping.

17. The method of claim 13, further comprising automatically inhibiting a change made when updating the first generic data mapping based upon the second generic data mapping.

18. An apparatus, comprising:
at least one processor; and
program code configured upon execution by the at least one processor to generate a publication data mapping for use in publishing traveler profile data from a source system to a target system from among a plurality of target systems, the source system configured to store profile data for a plurality of travelers, wherein the program code is configured to generate the publication data mapping by:
accessing a first generic data mapping associated with the target system from a hierarchical collection of generic data mappings, wherein the hierarchical collection of generic data mappings defines a plurality of mapping elements, wherein each mapping element in the plurality of mapping elements defines a relationship between at least one source data element from the source system and a target data element from the target system, wherein the first generic data mapping defines a first mapping element that maps at least one source data element to a first target data element, and wherein the first generic data mapping is a descendent of a second data mapping in the hierarchical collection of generic data mappings, wherein the second generic data mapping defines a second mapping element that maps at least one source data element to a second target data element, and wherein the first generic data mapping inherits the second mapping element from the second generic data mapping; and
dynamically generating the publication data mapping based at least upon the first and second generic data mappings, the publication data mapping configured to convert source profile data from the source system and for a traveler into target profile data associated with the first and second target data elements for the target system based upon the first and second mapping elements defined in the first and second generic data mappings.

19. The apparatus of claim 18, wherein the program code is further configured to convert source profile data from the source system and for the traveler into target profile data for the target system using the publication data mapping, and to dynamically generate the publication data mapping in response to modifying a source profile for the traveler in the source system.

20. The apparatus of claim 19, wherein the first mapping element comprises a group that binds first and second source data elements from the source system to the first target data element, and wherein the program code is configured to convert the source profile data into target profile data by discarding source profile data associated with the second source data element in response to determining that no source profile data associated with the first source data element exists.

21. The apparatus of claim 18, wherein the source profile data is associated with a profile for the traveler, and wherein the program code is further configured to:
publish the profile by communicating the target profile data to the target system;
cache the publication data mapping after dynamically generating the publication data mapping; and
reuse the publication data mapping to publish a second profile in response to determining that the publication data mapping is cached.

22. The apparatus of claim 18, wherein the source profile data is associated with a profile for the traveler, and wherein the program code is further configured to:
publish the profile by communicating the target profile data to the target system;
cache the publication data mapping after dynamically generating the publication data mapping; and
dynamically regenerating the publication data mapping in association with publishing a second profile in response to determining that at least one generic data mapping used to dynamically build the publication data mapping has changed.

23. The apparatus of claim 18, wherein the second generic data mapping includes a third mapping element, and wherein the first mapping element overrides the third mapping element.

24. The apparatus of claim 18, wherein the second mapping element is read-only such that overriding of the second mapping element mapping element in the first generic data mapping is prohibited.

25. The apparatus of claim 18, wherein the program code is further configured to update at least one of the first and second generic data mappings in response to input received from a user associated with the target system, and automatically propagate a change made when updating the second generic data mapping to the first generic data mapping based upon the first generic data mapping being a descendent of the second generic data mapping.

26. A program product, comprising:
a computer readable medium; and
program code stored on the computer readable medium and configured upon execution to generate a publication data mapping for use in publishing traveler profile data from a source system to a target system from among a plurality of target systems, the source system configured to store profile data for a plurality of travelers, wherein the program code is configured to generate the publication data mapping by:
accessing a first generic data mapping associated with the target system from a hierarchical collection of generic data mappings, wherein the hierarchical collection of generic data mappings defines a plurality of mapping elements, wherein each mapping element in the plurality of mapping elements defines a relationship between at least one source data element from the source system and a target data element from the target system, wherein the first generic data mapping defines a first mapping element that maps at least one source data element to a first target data element, and wherein the first generic data mapping is a descendent of a second data mapping in the hierarchical collection of generic data mappings, wherein the second generic data mapping defines a second mapping element that maps at least one source data element to a second target data element, and wherein the first generic data mapping inherits the second mapping element from the second generic data mapping; and
dynamically generating the publication data mapping based at least upon the first and second generic data mappings, the publication data mapping configured to convert source profile data from the source system and for a traveler into target profile data associated with the first and second target data elements for the target system based upon the first and second mapping elements defined in the first and second generic data mappings.
